(19) United States
(12) Patent Application Publication
(10) Pub. No.: US 2017/0021808 A1
(43) Pub. Date: Jan. 26, 2017

(54) DEVICE FOR SECURING A BLADE OF A WIPER

(71) Applicant: Valeo Systèmes d'Essuyage, Le Mesnil Saint Denis (FR)

(72) Inventor: Guillaume Barret, Laps (FR)

(73) Assignee: Valeo Systèmes d'Essuyage, Le Mesnil Saint Denis (FR)

(21) Appl. No.: 15/215,644

(22) Filed: Jul. 21, 2016

(30) Foreign Application Priority Data
Jul. 24, 2015 (FR) 1557118

(51) Int. Cl. B60S 1/38

(52) U.S. Cl. CPC B60S 1/3891; B60S 1/3874

(57) ABSTRACT

A device (124) for securing a wiper blade (108) in a wiper (102), extending along a first longitudinal axis (XX), has both an end fitting (126) mounted on one longitudinal end (110) of said wiper blade (108) and a locking means (128) attached to said end fitting in order to lock said wiper blade inside said end fitting (126).

The locking means (128) consists of a clip having arms that are able to fit in receiving means (146, 148) formed in said end fitting (126), at least one of said arms bearing at least one claw (186).

And at least one of the receiving means (146, 148) is configured to deform said at least one arm such that said at least one claw is engaged in said blade.

The present invention relates to the field of wiping windows of motor vehicles, and notably the field of wiper assemblies. More precisely, the present invention relates to an end fitting which is mounted on at least one end of a wiper blade.

Vehicle windows are generally equipped with a wiper assembly having at least one wiper arm that is driven in rotation by motorized means, and a wiper disposed at the free end of the arm. Wipers generally comprise a holder for mounting a rubber blade that is able to be pressed against the window to be cleaned, and at least one end fitting for locking the blade in position in the holder. The blade is introduced into the mounting holder by being slid longitudinally and is locked in position by the end fitting, which is secured to a longitudinal end of the mounting holder and possibly to a longitudinal end of the blade, so as to prevent the blade from moving longitudinally with respect to the holder during the back-and-forth movement along the window to be cleaned that is brought about by the arm.

The present invention aims to provide an alternative to the known structures of end fittings, avoiding the drawbacks of the structures in which an attached element has to be crimped in order to lock the blade in position, or else the drawbacks of the structures in which the blade can be secured to the end fitting without necessarily being in the end position intended in theory.

In this context, the invention provides a device for securing a wiper blade in a wiper extending along a first longitudinal axis, having an end fitting mounted on one longitudinal end of said wiper blade and a locking means attached to said end fitting in order to lock said wiper blade inside said end fitting. According to the invention, the locking means is advantageously in the form of a clip having arms that are able to fit in receiving means formed in said end fitting, at least one of said arms bearing at least one catching means for catching the blade, notably in the form of a claw, such that when the arm is deformed by one of the receiving means during the insertion of the arm, said at least one claw is engaged in said blade.

According to various features, taken on their own or in combination, of a first set of features of the invention that are inherent to the structure of the end fitting:
the end fitting comprises a body having a first longitudinal end and a second longitudinal end; this body has a lower wall defined between the first end and the second end and a first end wall disposed transversely with respect to said first end; the lower wall is slotted from the first to the second longitudinal and of the body so as to define at least one cutout for receiving the wiper blade, said cutout opening onto said first end wall, forming a first opening;
the receiving means formed in the end fitting consist of cavities which extend in a direction parallel to said first longitudinal axis and which are disposed symmetrically on either side of the cutout, each cavity being able to receive one of said arms;
each of the cavities extends in a blind manner from a second opening is formed in the first end wall on either side of the first opening;
each cavity is delimited by two longitudinal walls, a first longitudinal wall of which extends in the vicinity of the cutout;

Provision can be made for only one of the cavities to be designed to deform an arm of the clip or for both cavities to be designed in the following manner:
the cavity or cavities has or have a first longitudinal wall in which a slot that opens into the cutout is formed; and said slot has a height at least equal to the thickness of said at least one claw of the dip forming a locking means;
the second longitudinal wall of the cavity or cavities has, from said second opening, a first, ramp-forming portion and a second, depression-forming portion, said first, ramp-forming portion being oriented in the direction towards said first longitudinal wall.

According to various features, taken on their own or in combination, of a first set of features of the invention that are inherent to the structure of the end fitting:
said clip forming a locking means is U-shaped, wherein a rear part is extended by arms, at least one arm having at least one claw, said at least one arm being able to be housed in said at least one cavity;
said at least one arm is flexible transversely in the direction of the other arm of the clip;
said at least one claw extends an internal wall of said at least one arm substantially perpendicularly;
said at least one arm has a notch formed in the external wall of said at least one arm.

Provision may be made for each of the arms of the clip forming a locking means to have at least one claw extending an internal well of the arm substantially perpendicularly, each arm being flexible transversely in the direction of the other arm of the clip, each arm having a notch formed in the external wall, and each arm being able to be housed in one of the receiving means that is able to deform said at least one arm such that said at least one claw is engaged in said blade.

The invention also relates to a method for mounting a device for securing a wiper blade in a wiper, during which the wiper blade is inserted into the end fitting through a first longitudinal end, so as to slide in a first direction in a longitudinal direction in a first recess in this end fitting unto the wiper blade juts out from said end fitting through the opposite second longitudinal end, and during which the clip forming a locking means is inserted into the end fitting through said second longitudinal end, in an opposite direction to the first direction in said longitudinal direction, pushing the wiper blade back inside the end fitting, until the clip is locked in position inside the end fitting in a final position in which it is engaged with the wiper blade.

The invention is described in detail by means of a plurality of non-limiting exemplary embodiments that are illustrated in the following figures, in which:

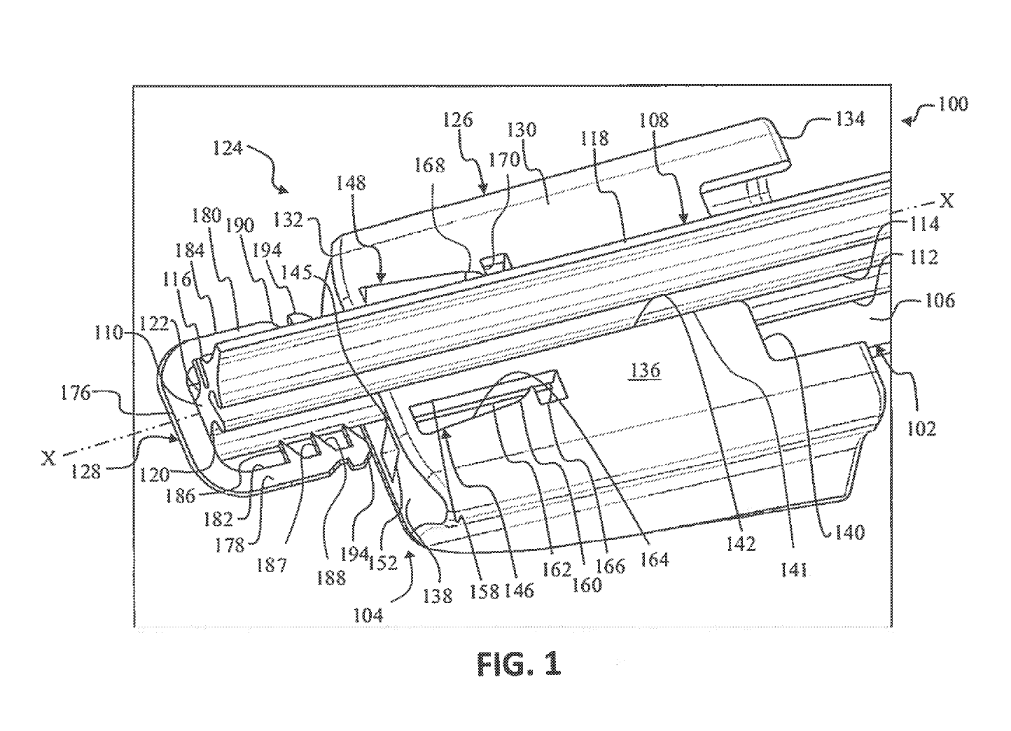

FIG. 1 is a perspective depiction of a wiper blade end and of an end fitting according to the invention, the assembly being seen in a bottom view;

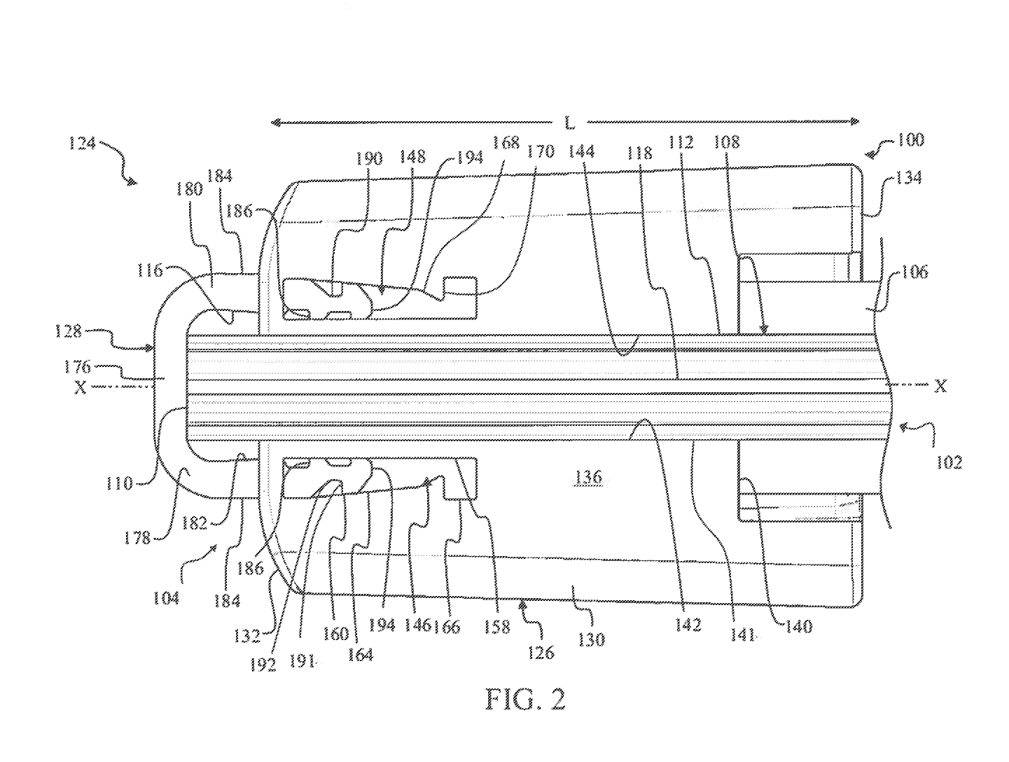

FIG. 2 is a bottom view of FIG. 1, the assembly being depicted in a preassembly position;

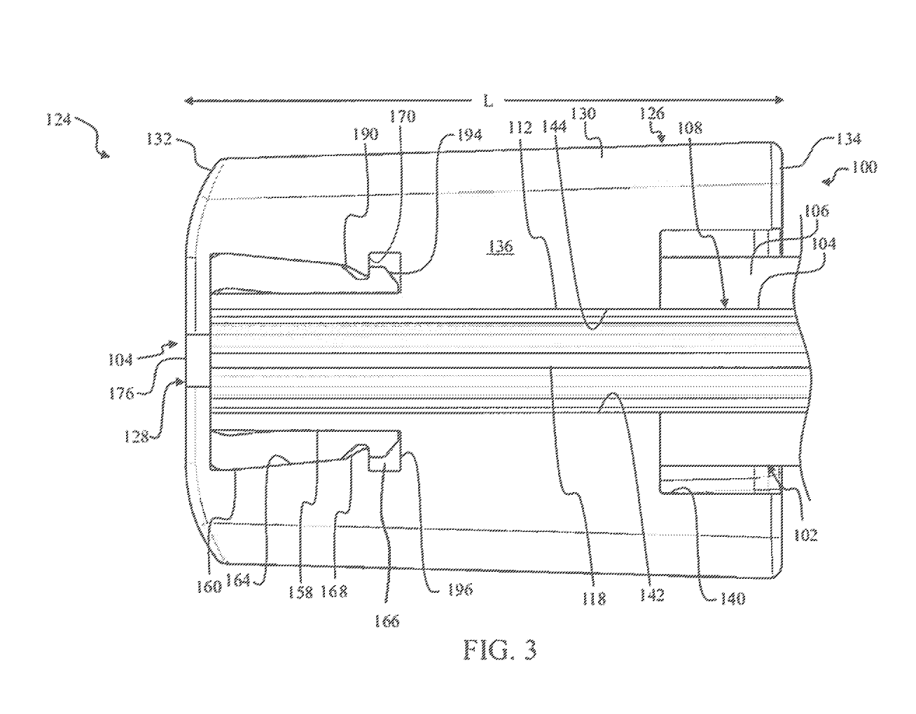

FIG. 3 is a view similar to FIG. 2, the assembly this time being depicted in a final assembly position; and

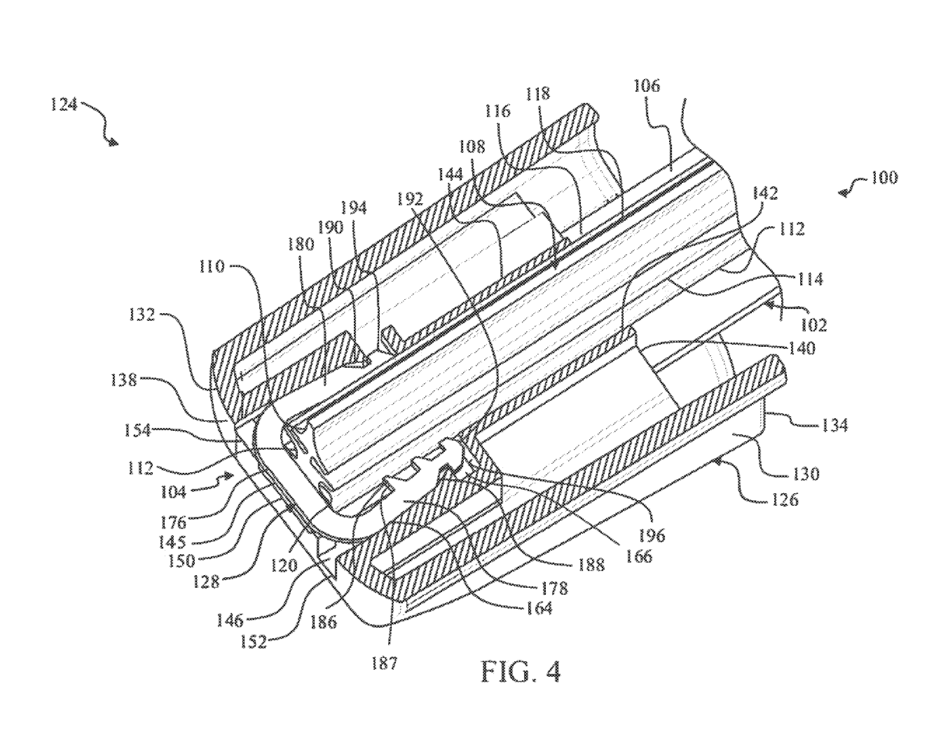

FIG. 4 is a view, at the same perspective angle as the one used in FIG. 1, of the assembly in the final assembly position in FIG. 3, in which the end fitting is depicted in cross section in order to make it easier to understand.

FIG. 1 depicts a longitudinal end of a wiper assembly 100 for cleaning windows of a motor vehicle. This wiper assembly 100 has a wiper arm (not depicted here) and a wiper 102. The wiper arm is an arm which is mounted so as to pivot, driven back and forth in contact with a surface of the window, and which is coupled to the wiper 102 via a connector (not depicted).

The wiper 102 extends mainly longitudinally along a first longitudinal axis XX and one of the longitudinal ends 104 of said wiper 102 has been depicted in the various figures, it being understood that the description given for one longitudinal end can be reproduced in an identical manner for the opposite longitudinal end.

The wiper 102 comprises a mounting holder (not shown here) which is connected to the connector and which supports stiffening vertebrae 106 that are disposed longitudinally in receiving notches of a wiper blade 108. The mounting holder, the vertebrae 106 and the wiper blade 108 are longitudinal elements that extend along the first longitudinal axis X.

By way of example, the stiffening vertebrae can consist of simple flexible metal strips that are housed on either side of the rubber blade in order to give the latter both longitudinal integrity and flexibility to adapt to the curvature of the window to be wiped. The wipers of this type are notably referred to as “flat-blade” wipers.

The wiper blade 108 is also partially depicted such that it is possible to see that its longitudinal end 110 corresponds to the longitudinal end 104 of the wiper. The wiper blade 108 has a head 112, in which the stiffening vertebrae 106 are able to be slid into corresponding notches (not visible here), and a body 114 which notably has fins 116 and a lip 118. The body 114 is designed so as to define two opposite longitudinal grooves 120 and 122 between the vertebrae 106 and the fins 116.

At each longitudinal end 104 of the wiper 102, the corresponding longitudinal ends of the stiffening vertebrae 106 and of the wiper blade 108 are held together in a locked manner with the aid of a securing device 124 which has an end fitting 126 and an attached locking means 128 which is able to move so as to fit in the end fitting and serve to lock the blade. As will be described in more detail below, the locking means is able to move between a preassembly position and a final position, in which the locking means is locked in the end fitting in a position locking the blade.

The end fitting 126 has a body 130 which extends between a first longitudinal end 132 and a second longitudinal end 134. The first longitudinal end 132 corresponds to the end facing towards the outside of the wiper when the end fitting is disposed at the longitudinal end 104 of this wiper, such that it is via the second longitudinal end 134, opposite the first longitudinal end 132, that the securing end fitting is mounted on the wiper 102.

The body 130 has a lower wall 136 and an upper wall (not visible in the figures), which extend respectively between the two longitudinal ends, and a first end well 138 which is positioned at the first longitudinal end 132 of the body 130.

The lower wall 136 is slotted from the first to the second longitudinal end of the body, so as to define a first recess 140. The first recess 140 extends along the entire length L of the body 130 and has a first notch formed from the second longitudinal end 132 and extended longitudinally by a cutout 141 delimited by two mutually opposed edges 142 and 144 (depicted notably in FIG. 2). The cutout 141 is dimensioned such that the edges 142 and 144 extend next to the longitudinal grooves 120 and 122 in the wiper blade 108 when the end fitting 126 is mounted by sliding along the blade. The edges 142 and 144 of the cutout 141 are thus configured to guide the wiper blade 108 through the first recess 140, such that the end fitting can slide along the blade in order to take up the preassembly position illustrated in FIGS. 1 and 2. The first recess 140 is a through-recess such that it opens onto the first end wall 138, forming a first opening 145.

Moreover, the body 130 of the end fitting 126 has two cavities 146 and 148 that are disposed symmetrically on either side of the cutout 141. These two cavities form means for receiving locking means 128 in the end fitting 126. Each of the cavities extends in a blind manner from a second opening 152, 154 formed in the first end well 138 on either side of the tint opening 145.

An impression 150 is furthermore defined in the thickness of this first end wall to connect the first openings 152, 154 together, and this impression 150 extends through the first opening 145, as can be seen in FIG. 4, for example.

Each cavity 146, 148 is delimited transversely by a first longitudinal wall 158 and a second longitudinal wall 160. The first longitudinal wall 158 extends in the vicinity of the cutout 141, substantially parallel to the first longitudinal axis XX. The first longitudinal wall 158 has a longitudinal slot 162 which extends along the entire length of the cavity and notably from the first end wall 138 at which the cavity opens out. This longitudinal slot 162 is notably visible in FIG. 1, it being understood that the section plane in FIG. 4 passes through this longitudinal slot. As can be seen better in FIG. 4, the longitudinal slot 162 is a through-slot, that is to say that it opens from one side of the first longitudinal well 158 onto the corresponding cavity 146, 148, and it opens from the other side of this first wall onto the cutout 141 at the centre of the end fitting. The second longitudinal wall 160 has a first, ramp-forming portion 164 and a second, depression-forming portion 166. The first, ramp-forming portion 164 extends from the first end wall 138 and is oriented in the direction towards the first longitudinal wall 158. As can be seen in the figures, and referenced in FIGS. 2 and 3, this first, ramp-forming portion 164 has a steeply sloping terminal part 168 at its end disposed inside the cavity, at the unction with the second, depression-forming portion 166. The second, depression-forming portion 166 is realized by a transverse depression in continuation of the first, ramp portion 164, forming a shoulder 170.

An embodiment in which the two cavities have a similar shape has been depicted in the figures. As will be presented as a variant below, the second cavity 148 could have a straight shape, delimited by two parallel longitudinal walls and without a longitudinal slot in the wall extending in the vicinity of the cutout.

In all cases, the structure of the end fitting 126 is designed to receive and cooperate with the locking means 128. The locking means 128 comprise a U-shaped clip with a rear part 176, a first arm 178 and a second arm 180, each of the arms extending an end of the rear part 176 substantially perpendicularly. The two arms are flexible transversely such that they are capable of moving away from or towards one another.

Each arm 178, 180 has an internal face 182 and an external face 184. The internal face 182 has three claws 186, the clip 128 thus being designed such that the claws of the first arm 178 are directed towards the claws of the second arm 180. The claws 186 have a pointed shape with a straight face 187, perpendicular to the internal face 182, and an inclined face 188, the straight face 187 being the face closest to the rear part 176 of the dip. The thickness of each of the claws 186 is less than the depth of the longitudinal slots formed in the first longitudinal wall of the cavities 146, 148 so as to be able to be slid inside these slots, as will be described below. As illustrated, the arms and the rear part have the same thickness, but it will be understood that the thickness of the rear part could be greater as long as the thickness of the claws is as has just been specified, less than or at most substantially equal to the depth of the longitudinal slots. In variant embodiments, the number of claws 186 can be modified.

The external face 184 of each of the arms has a notch 190 delimited by a substantially straight front edge 191, forming a shoulder, and an inclined rear edge 192, as can be seen in FIG. 2. Finally, each arm has at its free end a head 194 which extends beyond the notch 190 and which forms an abutment wall substantially perpendicular to the external and internal faces.

The method for assembling the securing device 124 at the end of the wiper will now be described, in order to explain in detail the cooperation of the locking means 128 and the end fitting 126 in order to fix the position of the wiper blade 108.

The end fitting 126 is placed in front of the longitudinal end 104 of the wiper 102 such that the blade can pass into the first recess 140. The head of the blade 112 is engaged inside the end fitting, held by the edges 142 and 144 delimiting the cutout 141 of the first recess 140. These edges are next to the longitudinal grooves 120 and 122 in the rubber blade 108, so as to make it easier for the blade to slide in the end fitting in the direction of the first end 132. The end fitting and the wiper are slid longitudinally with respect to one another such that the blade 108 juts out from the first longitudinal end 132 of the end fitting, so as to take up a position illustrated in FIG. 1.

In FIG. 1, the dip 128 forming the locking means is placed against the longitudinal end 110 of the wiper blade 108 such that the rear part 176 of the clip presses against the blade and the arms 178 and 180 are disposed either side of the blade. The clip is pushed towards the end fitting 126, ensuring that each arm passes into one of the cavities 146, 148, with the external face 184 of each arm bordering the second longitudinal wall 160 of the corresponding cavity and the claws 186 being housed in the longitudinal slot 162 formed in the first longitudinal wall 158 of this cavity, so as to be in the position illustrated in FIG. 2, which corresponds to a preassembly position in which the two elements of the securing device 124, namely the end fitting 126 and the clip 128, cooperate. It will be understood that the pushing of the clip 128 causes the blade 108 to slide in the first recess 140 such that the longitudinal end 110 of the blade tends to move towards the longitudinal end 104 of the wiper. The direction of this movement is opposite to the initial insertion direction of the wiper blade 108 into the end fitting 126.

In order to pass from this preassembly position into a final assembly position illustrated in FIGS. 3 and 4, the clip which forms the locking means 128 continues to be pushed towards the inside of the end fitting. The first, ramp-forming portion 164 of the second longitudinal wall 160 of the cavity forces the arm 178 to deform elastically so as to move towards the other arm 180 of the clip, and this deformation causes the claws 186 to penetrate more deeply into the longitudinal slot 162, until they pass through the first longitudinal wall in order to be engaged in the rubber of the wiper blade 108, substantially at the level of the longitudinal grooves 120 and 122. The blade and the dip are thus fixed in terms of longitudinal movement. It will be understood that the claws 186 form catching means for catching the blade, and that such catching means could have a form different from that of a claw as illustrated, as long as the deformation of one arm of the dip causes the catching means to engage with the blade. The steeply sloping terminal part 168 ensures that the claws penetrate into the blade sufficiently deeply to obtain secure anchoring. The blade and the clip are both pushed until the head 194 at the end of the arm passes into the second, depression-forming portion 166 formed in the second longitudinal we 160 of the corresponding cavity. In this position, illustrated in FIGS. 3 and 4, which corresponds to the final assembly position of the securing device, the head 194 of each arm is housed in the second, depression-forming portion and the substantially straight front edge 191 of the notch 190 prevents the clip from detaching longitudinally rearwards with respect to the end fitting, by abutment against the shoulder 170. Furthermore, the end wall of the head 194 of each arm comes into abutment against a bottom wall 196 of the cavity (visible in FIGS. 3 and 4), which limits the longitudinal forward movement of the clip and of the blade with respect to the end fitting. In this abutting position, it can be seen that the rear part 176 of the dip is housed in the impression 156 so as not to jut out from the end fitting.

It will be understood that, in the final position, the locking means are secured both to the end fitting, by the cooperation of snap-fastening means formed by the head of the arms and the shoulder in the corresponding cavities, and to the blade, which cannot detach longitudinally through the second longitudinal end 134 of the end fitting on account of the engagement of the claws 186 in the rubber of the wiper blade. It can be seen that the shape of the claws, and notably the straight face 187 and its orientation towards the rear part 176 of the clip, that is to say in the opposite direction to the direction of possible detachment of the blade through the second longitudinal end of the end fitting, prevents the blade from being pulled out.

The above description aims to explain how the invention can achieve the objectives set therefor and notably to provide a securing device which makes it possible to keep the blade and the stiffening vertebrae of a wiper in position, said securing device being particularly simple to implement and very effective at securing the blade.

Of course, various modifications can be made by a person skilled in the art to the structures of the wiper assembly which have just been described by way of nonlimiting examples, as long as a securing device is provided that has an end fitting provided with means for receiving an attached part, the insertion of which into the end fitting produces effective securing, that is to say securing which is irreversible and in the desired position, of the wiper blade otherwise inserted into the end fitting.

1. A device for securing a wiper blade in a wiper extending along a first longitudinal axis, the device comprising:
an end fitting mounted on one longitudinal end of said wiper blade; and
a locking means attached to said end fitting in order to lock said wiper blade inside said end fitting,
wherein said locking means consists of a clip having arms that are able to fit in receiving means formed in said end fitting, at least one of said arms bearing at least one catching means, and
wherein at least one of the receiving means is configured to deform said at least one arm such that said at least one catching means is engaged in said blade.

2. The securing device according to claim 1, wherein the end fitting comprises a body having a first end and a second end, said body comprising a lower wall defined between the first end and the second end and a first end wall disposed transversely with respect to said first end, said lower wall being slotted from the first to the second longitudinal end of the body so as to define at least one cutout for receiving the wiper blade, said cutout opening onto said first end wall, forming a first opening.

3. The securing device according to claim 2, wherein said receiving means formed in the end fitting consist of cavities which extend in a direction parallel to said first longitudinal axis and which are disposed symmetrically on either side of the cutout, each cavity being able to receive one of said arms.

4. The securing device according to claim 3, wherein each of the cavities extends in a blind manner from a second opening formed in said first end wall on either side of the first opening.

5. The securing device according to claim 3, wherein each cavity is delimited by two longitudinal walls, a first longitudinal wall of which extends in the vicinity of the cutout.

6. The securing device according to claim 5, wherein at least one cavity has a first longitudinal wall in which a slot that opens into the cutout is formed.

7. The securing device according to claim 6, wherein said slot has a height at least equal to the thickness of said at least one catching means of the clip forming a locking means.

8. The securing device according to claim 6, wherein the second longitudinal wall of said at least one cavity has a first, ramp-forming portion and a second, depression-forming portion, said first, ramp-forming portion being oriented in the direction towards said first longitudinal wall.

9. The securing device according to claim 5, wherein the two cavities have a first longitudinal wall in which a slot that opens into the cutout is formed, and a second longitudinal wall in which a first, ramp-forming portion and a second, cavity-forming portion are formed, said first, ramp-forming portion being oriented in the direction towards said first longitudinal wall.

10. The securing device according to claim 6, wherein said clip forming a locking means is U-shaped, wherein a rear part is extended by arms, at least one arm having at least one catching means, said at least one arm being able to be housed in said at least one cavity.

11. The securing device according to claim 10, wherein said at least one arm is flexible transversely in the direction of the other arm of the clip forming a locking means.

12. The securing device according to claim 10, wherein said at least one catching means extends an internal face of said at least one arm substantially perpendicularly.

13. The securing device according to claim 10, wherein said at least one arm has a notch formed in the external face of said at least one arm.

14. The securing device according to claim 10, wherein each of the arms of the clip forming a locking means has at least one catching means extending an internal wall of the arm substantially perpendicularly, each arm being flexible transversely in the direction of the other arm of the clip, each arm having a notch formed in the external wall, and each arm being able to be housed in one of the receiving means that is able to deform said at least one arm such that said at least one catching means is engaged in said wiper blade.

15. A method for mounting a device for securing a wiper blade in a wiper according to claim 1, the method comprising:
inserting the wiper blade into the end fitting through a first longitudinal end, so as to slide in a first direction in a longitudinal direction in a first recess in this end fitting until the wiper blade juts out from said end fitting through the opposite second longitudinal end; and
inserting the clip forming a locking means into the end fitting through said second longitudinal end, in an opposite direction to said first direction in said longitudinal direction, pushing the wiper blade back inside the end fitting, until the clip is locked in position inside the end fitting in a final position in which the clip is engaged with the wiper blade.
